(19) United States
(12) Patent Application Publication
(10) Pub. No.: US 2016/0087573 A1
(43) Pub. Date: Mar. 24, 2016

(54) MULTI-FUNCTION FLOATING SOLAR POWER GENERATING SYSTEM

(71) Applicant: INSTITUTE OF NUCLEAR ENERGY RESEARCH, ATOMIC ENERGY COUNCIL, EXEC. YUAN, R.O.C., TAOYUAN COUNTY (TW)

(72) Inventors: HSI-HUNG YANG, TAOYUAN COUNTY (TW); WEI-YANG MA, TAOYUAN COUNTY (TW); TSUN-NENG YANG, TAOYUAN COUNTY (TW); CHENG-DAR LEE, TAOYUAN COUNTY (TW)

(21) Appl. No.: 14/853,203

(22) Filed: Sep. 14, 2015

(30) Foreign Application Priority Data
Sep. 19, 2014 (TW) 103132373

(51) Int. Cl. H02S 20/00; B63B 22/00; B63B 35/44; H02S 30/10

(52) U.S. Cl. CPC H02S 20/00; H02S 30/10; B63B 22/00; B63B 35/44; B63B 2035/4453

(57) ABSTRACT

The present Invention relates to a multi-function floating solar power generating system, which uses buoys to form buoy sets. A convergence box is used as the center for forming a cross structure, on which solar cell modules installed at an inclination angle of 10 to 15 degrees are carried. According to the present invention, a water-pumping unit below the buoy set is used for pumping the fluid. Then a spray unit is used for spraying the fluid and driving the system to rotate counterclockwise or clockwise, hence achieving the effect of tracking the sun. Alternatively, the fluid can be filtered or used for cleaning the solar cell module.

### FIELD OF THE INVENTION

The present invention relates generally to a solar power generating system, and particularly to a multi-function floating solar power generating system having the functions of floating on the surface of a fluid, solar tracking for maintaining high power generating efficiency, water cleaning, and self-cleaning.

### BACKGROUND OF THE INVENTION

The development of renewable energy resources, whether wind, geothermal, hydroelectric, or solar power generation, requires a certain area of land. Due to the continuous increase in population, the future supply of land will be tight and costly. The demand in land also threatens the environmental quality of human residences and the production conditions of food. In recent years, the development of floating solar energy has been promoted progressively worldwide, and thus enabling the application and development of solar power generation to grow rapidly.

Although solar power generation is a renewable energy resource having the greatest potential, there are many challenges for floating solar power generation. The area required by a solar power plant to give the power capacity comparable to a tradition power plant while maintaining stable power supply is hundreds or even thousands of times the area of a tradition power plant. Accordingly, moving power plants to the water surface will utilize the idle space effectively. Water covers around ¾ of the total area of the planet surface. In order to utilize the space and resource of water surface. Installing the solar power generation system on the oceans, lakes, or reservoirs is a future trend. In addition to using the environmental advantages and space, this method can induce other significant benefits as well such as lowering the temperature of the seawater, alleviating the greenhouse effect, reducing the evaporation of the fresh water in the reservoirs, and improving the water quality of reservoirs.

Technically, it is not difficult to float the whole system on water. Nonetheless, there are still technical challenges to achieve a win-win situation by fully utilizing the local environment and water resources as well as improving the efficiency of solar plants and the quality of water.

Modern floating solar plants mainly adopt the construction of placing solar panels flat on buoys directly. Because the solar panels are faced directly toward the sun, the power generating efficiency is worse in the mornings and evenings. Another method is to place solar panels on supporting frames on buoys and face to the east at an inclination of 30-45 degrees. This method has the shadowing problem at the connections of solar panels and affecting the power generating efficiency directly. Even for photovoltaic tracking and concentrating floating solar systems, complicated mechanical mechanisms induce problems. Long-term placement on water surfaces results in rust and thus requires frequent maintenance and repair. Additionally, the mechanical structures tend to rotate with the wind, and to fluctuate up and down with the water's movement. Consequently, the power generating efficiency is affected.

All current commercial floating solar power generating systems do not take advantages of the water environment but simply use the water surface for installing the solar systems. Floating solar systems usually require piles for positioning and maintenance pathways for system maintenance. This method complicates the mechanisms and adds weight to the system. Even when the overall system adopts a photovoltaic tracking system, the complicated mechanical tracking is disadvantageous to long-term placement on water and results in a high failure rate. None of the above methods can make good use of sunlight resources for the whole day. In addition, the properties and advantages of water surfaces are not utilized well.

### SUMMARY

An objective of the present invention is to provide a multi-function floating solar power generating system, which includes a spray function for pushing the system to rotate on the fluid surface by side spraying. Thereby, the supported solar cell modules can have the preferred sunlight angle.

Another objective of the present invention is to provide a multi-function floating solar power generating system, which adopts massive buoys to form multiple buoy sets for arrangement. The convergence box is the center and the buoy sets extend outwards, making the structure stable. In addition, the system area is expanded and reduced with ease, thus facilitating repair and maintenance.

Still another objective of the present invention is to provide a multi-function floating solar power generating system, which can float on a fluid. Thereby, the problem of land demand for solar power generating systems can be solved. Moreover, the evaporation rate of the fluid is reduced, which is beneficial to reserving water for reservoirs and catch basins.

in order to achieve the objective as described above, the present invention discloses a multi-function floating solar power generating system, which floats on a fluid and comprises a convergence box, two or more buoys, a surrounding frame, one or more supporting frame, and one or more solar cell module. One end of each of the two or more buoys is connected to the side edges of the convergence box, respectively. The surrounding frame includes a plurality of fixing holes. The other end of each of the plurality of buoys is connected to the plurality of fixing holes, respectively. The one or more supporting frame is disposed on the plurality of buoys. The one or more solar cell module is disposed on the supporting frame. The plurality of buoys Includes a plurality of spray units on the outer side. The multi-function floating solar power generating system includes a water-pumping unit. The plurality of spray units are connected with the water-pumping unit. The water-pumping unit extracts from the fluid and spray the extracted fluid via the plurality of spray units.

### BRIEF DESCRIPTION OF THE DRAWINGS

FIG. 1 shows a schematic diagram according to a preferred embodiment of the present invention;

FIG. 2 shows an exploded view according to a preferred embodiment of the present invention;

FIG. 3A shows a cross-sectional view along the segment A in FIG. 1;

FIG. 3B shows a cross-sectional view with a hinge according to another preferred embodiment of the present invention;

FIG. 4 shows a schematic diagram of the location of the spray unit according to a preferred embodiment of the present invention;

FIG. 5 shows a schematic diagram of the spray/water-pumping system according to a preferred embodiment of the present invention; and

FIG. 6 shows a path diagram of water flow according to a preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

According to the multi-function solar power generating system of the present invention, the solar module is disposed on fluid to solve the problems of land utilization and heat dissipation if the solar module is disposed on land. In addition, it includes the function of tracking the sun, avoiding the worries of reduction in the power generating efficiency as the power generating system is moved to the water surface.

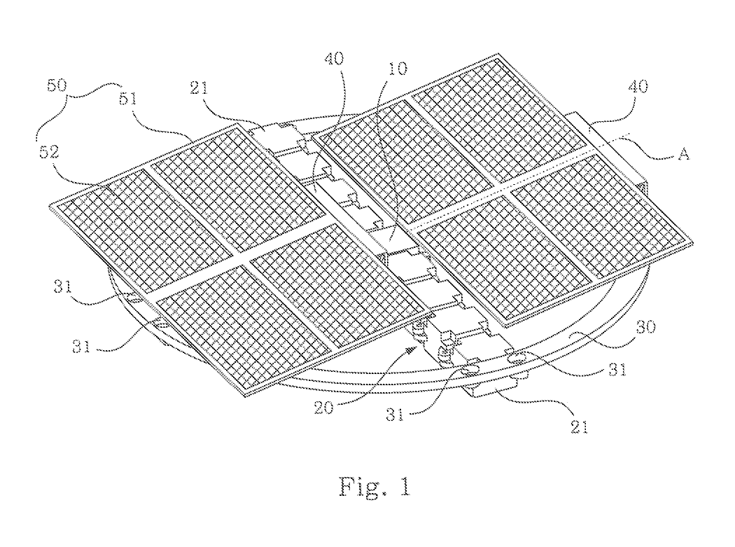

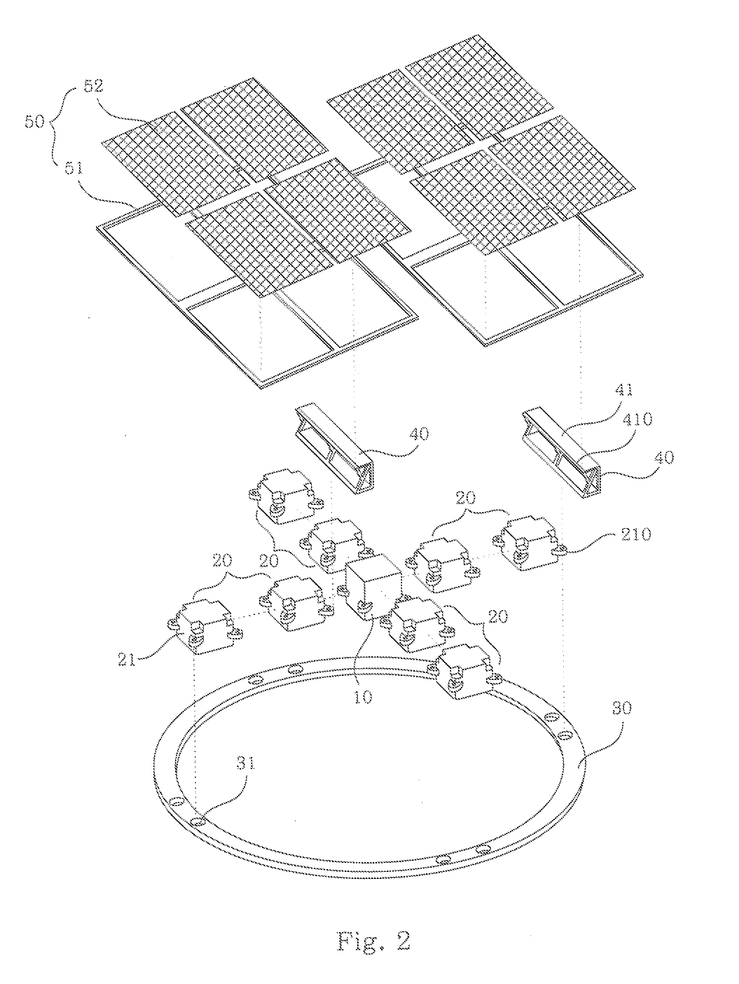

Please refer to FIG. 1 and FIG. 2, The structure according to the present embodiment comprises a convergence box 10, a plurality of buoy sets 20, a surrounding frame 30, one or more supporting frame 40, and one or more solar cell module 50. One end of the buoys 21 in the plurality of buoy sets 20 is connected to the side edges of convergence box 10, respectively. The other end thereof extends outwards from the convergence box 10 and is connected with the surrounding frame 30. The supporting frame 40 is disposed on the buoy 21. The solar cell module 50 is disposed on the supporting frame 40.

In the above structure, the convergence box 10 is the device for electrically controlling the whole power generating system and collecting the currents. In other words, it is the place for disposing the battery. According to the present embodiment, the convergence box 10 is the center of the structure. The buoy sets 20 are disposed on the periphery. Preferably, the arrangement is a cross shape. Each of the buoy sets 20 is formed by one or more buoy 21. The whole power generating system requires two or more buoys 21 disposed on both side edges of the convergence box 10. The plurality of buoys 21 have cubic structures and are connected sequentially on respective buoy set 20. Thereby, the buoy set 20 having multiple buoys 21 exhibits a long chain shape. As described above, the other end of the buoy set 20 uses the convergence box 10 as the center and extends towards the outward direction of convergence box 10. Consequently, one end of the long-chain shaped buoy set 20 is first connected to the convergence box 10 and then extends towards the four outwards directions of the convergence box 10, thus forming the cross-shaped floating base. The advantage of the cross shape is its superior stability. A trade-off is made between the effect of stability and the number of buoys.

In order to fix the cross structure, the other end of the buoy set 20 is fixed at the surrounding frame 30. The surrounding frame is annular with a plurality of fixing holes 31. The buoy set 20 can hook to the plurality of fixing hole 31 or appropriate connecting members can be adopted for positioning to the plurality of fixing holes 31. For example, plugs can be used to pass through fixing rings 210 and the fixing holes 31 on the surrounding frame 30. The annular surrounding frame 30 reduces the water resistance of the system when the whole system rotates and tracks the sun, and thus reducing the energy consumption during rotation. As shown in FIG. 2, the surrounding frame 30 has four sets of fixing holes 31 distributed uniformly on the annular structure and suitable for the arrangement of the cross-shaped buoy sets 20 according to a preferred embodiment of the present invention. If the buoy sets 20 are further arranged in a symmetrical pattern, other uniformly distributed fixing holes 31 can be added accordingly.

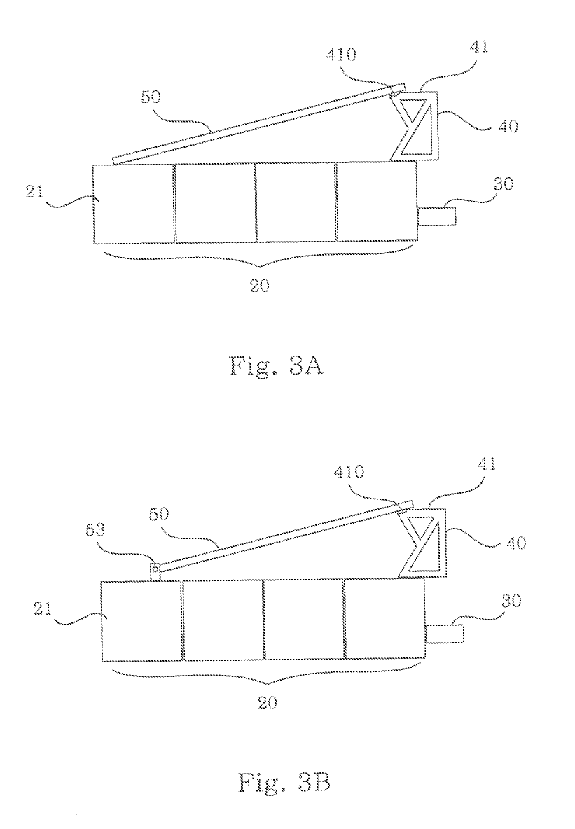

In addition to fixing the buoy sets 20, the fixing holes can also be used to fix the supporting frames 40 used for supporting the solar cell modules 50. As shown in FIG. 2, two supporting frame 40 are disposed on both sides of the cross-shaped mechanism according to the preferred embodiment of the present invention. The supporting frames 40 are disposed on the buoys 21. Buckle devices, frame tenons, or plugs can be used to combine with the fixing rings 210 of the buoys 21 and thus fix the supporting frames 40 to the fixing holes 31. The supporting frame 40 includes a groove 410 on the supporting surface 41 of the structure. The groove 410 is used for supporting one end of the solar cell module 50, hence raising the height of the solar cell module 50 and forming an inclination angle of 10 to 15 degrees. Consequently, the purpose of facing directly into the sunlight can be achieved. The other end of the solar cell module 50 is disposed on the buoy 21 (as shown in FIG. 3A) or the surrounding frame 30 and lower than the end supported by the supporting frame 40. According to a preferred embodiment of the present invention, as shown in FIG. 3B, a hinge 53 can be further used for disposing the solar cell module 50 on the buoy 21 or the surrounding frame 30 (not shown in the figure). This hinge 53 can be disposed at the fixing hole 31 of the surrounding frame 30. The hinge 53 enables the solar cell module 50 to rotate and changes the inclination angle as described above, thus increasing convenience in maintenance such as lifting the solar cell module 50 for examination or replacing the shadowed buoy 21 or the pipes and devices attached thereto.

The solar cell module 50 is formed by the frame 51 and a plurality of solar cell panels 52. The frame 51 is designed to be adjustable. The size of the frame 51 can be thus adjusted according to the size of the solar cell panels 52. Alternatively, the size and shape of the frame 51 can be selected according to the number of buoys 21 adopted by the system, the size of the buoy set 20, and/or the size of the surrounding frame 30.

In a large-area water area, the temperature on the water surface is lower than that on the land surface. In addition, the reflection of the sunlight is stronger on the water surface. Thereby, when the sunlight illuminates directly on the solar panels at noon, the temperature of the solar panels can be reduced by installing them close to the water surface. Additionally, according to the present embodiment, double-sided solar cell panels can be installed for taking advantage of the reflection from the water surface, thus improving the power generating efficiency.

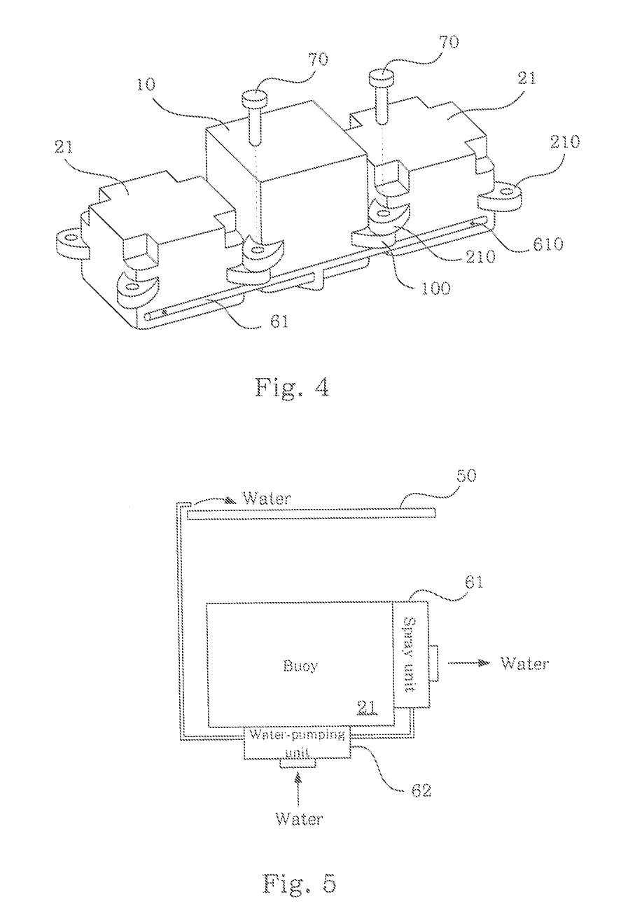

Please refer to the schematic diagrams shown in FIG. 4 and FIG. 5. The sun-tracking function according to the present invention can be achieved by disposing a plurality of spray units 61 on the sides of the buoys 21 and the water-pumping unit 62 below the buoys 21 (or the convergence box 10). The spray units 61 and the water-pumping unit 62 are controlled by an electronic control unit 101 inside the convergence box 10. The water-pumping unit 62 can pump water from the fluid surrounding the system. The pumped water is then sprayed from the spray nozzle 610 of the spray unit 61. As water is sprayed from the spray nozzle 610, by using the principle of active and reactive force, the buoy 20 can move towards the direction opposite to the direction of the spray. Because the arrangement of the buoy set is cross-shaped and the spray unit 61 are disposed in pairs at the buoy set, when the spray units 61 operate, according to a preferred embodiment, the convergence box 10 is the symmetric center and water should be sprayed counterclockwise or clockwise from two sites of the two buoy sets. For example, a spray unit is disposed on both sides of each of the two buoy sets in any direction of the cross, respectively. Thereby, the spray nozzles face to different directions and hence forming the basis for driving clockwise or counterclockwise. The system according to the present invention will then rotate clockwise or counterclockwise about the convergence box 10 and hence changing the illumination angle of the sunlight on the solar cell module 50. As a consequence, the sun-tracking effect is achieved. By maintaining long-term straight illumination of the sun, the preferred power generating efficiency can be attained. The water-pumping unit 62 is disposed below the multi-function floating solar power generating system. Thereby, the pumping process will not drive the system to rotate on the fluid surface.

FIG. 4 shows the connection between the buoys 21 and convergence box 10. As shown in the figure, the buoys 21 and convergence box 10 include a plurality of fixing rings 210, 100 on the side edges. Thereby, the fixing rings of the convergence box 10 and the plurality of buoys 21 can stack and overlap reciprocally and fixed by passing though the plugs 70.

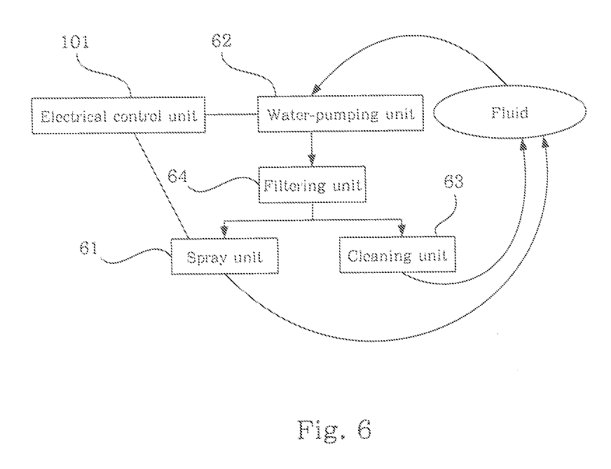

Furthermore, please refer to the path diagram of water flow as shown in FIG. 6. In addition to spraying purpose for the spray units 61, the water pumped by the water-pumping unit 62 can be moved to a cleaning unit 63 adjacent to the solar cell module 50 through pipes for cleaning the surface of the solar cell module 50. After long-term usage, the solar cell module 50 unavoidably will be covered by dusts in the air or dirty materials such as droppings, reducing the power generating efficiency. Accordingly, periodical cleaning is required. According to the present preferred embodiment of the present invention, the water of the fluid can be pumped to clean the surface of the solar cell module 50.

Additionally, according to the present embodiment, the water-pumping unit 62 can be further combined with a filtering unit 64. After the water-pumping unit 62 pumps the water from the fluid, the filtering unit filters the water and removes impurities before the spray unit 61 spraying the water or cleaning the solar cell module 50. In other words, the installation of the filtering unit 64 enables the multi-function floating solar power generating system according to the present embodiment to have the function purifying water for filtering out materials such as silt, germs, organic suspended particulates, or heavy metals.

To sum up, these embodiments of the present invention disclose a multi-function floating solar power generating system, which uses buoys to form a cross structure. By considering the area and shape of the water field, the size and design of the assembly can be adjusted. The whole mechanism makes use of the floating principle and utilizes the local water resource for pumping the water required by the system. In addition, by using the principle of active and reactive force and disposition of pipes, the effects of rotational sun-tracking and of cleaning the floating mechanism can be achieved. Additionally, according to the present invention, the solar cell modules can be installed, replaced, and maintained rapidly. The solar cell modules can be configured to have an inclination angle for maintaining the expected efficiency when the environment or weather changes. Accordingly, the present invention undoubtedly provides a multi-function floating solar power generating system with practical and economic values.

Accordingly, the present invention conforms to the legal requirements owing to its novelty, nonobviousness, and utility. However, the foregoing description is only of embodiments of the present invention, and does not limit the scope and range of the present invention. Those equivalent changes or modifications made according to the shape, structure, feature, or spirit described in the claims of the present invention are included in the appended claims of the present invention.

What is claimed is:

1. A multi-function floating solar power generating system, floating on a fluid, comprising:
a convergence box;
two or more buoys, with one end connected to the side edges of said convergence box, respectively;
a surrounding frame, having a plurality of fixing holes, and the other end of said plurality of buoys connected to said plurality of fixing holes, respectively;
one or more supporting frame, disposed on said plurality of buoys; and
one or more solar cell module, disposed on said supporting frame;
where said plurality of buoys include a plurality of spray units on the outer sides;
said multi-function floating solar power generating system includes a water-pumping unit below; said plurality of spray units are connected with said water-pump unit; said water-pump unit pumps said fluid; and said plurality of spray units spray the pumped fluid.

2. The multi-function floating solar power generating system of claim 1, wherein said plurality of buoys are arranged in a cross using said convergence box as the center.

3. The multi-function floating solar power generating system of claim 1, wherein a supporting face of said supporting frame includes a groove.

4. The multi-function floating solar power generating system of claim 3, wherein one end of said solar cell module is disposed on said groove to enable said solar cell module to have an Inclination angle of 10 to 15 degrees.

5. The multi-function floating solar power generating system of claim 1, wherein a filtering unit is further disposed between said water-pumping unit and said plurality of spray units.

6. The multi-function floating solar power generating system of claim 1, wherein said water-pumping unit is further connected with a cleaning unit used for cleaning said solar cell module by using water.

7. The multi-function floating solar power generating system of claim 1, wherein said water-pumping unit and said plurality of spray units are further connected with an electrical control unit disposed in said convergence box.

8. The multi-function floating solar power generating system of claim 1, wherein said solar cell module comprises a frame and one or more solar cell panel.

9. The multi-function floating solar power generating system of claim 8, wherein said solar cell panel is double-sided.

10. The multi-function floating solar power generating system of claim 1, wherein the spray nozzles of said plurality of spray units are arranged in pairs and spray water clockwise or counterclockwise by using sad convergence box as the center.

11. The multi-function floating solar power generating system of claim 1, wherein said convergence box and said plurality of buoys include a plurality of fixing rings on the side edges; said fixing rings of said convergence box and said plurality of buoys can stack and overlap said fixing rings of adjacent buoys; and said fixing rings are fixed by passing through plugs.

12. The multi-function floating solar power generating system of claim 4, wherein said the other end of said solar cell module includes a hinge connected with said plurality of buoys or said surrounding frame.
